(19) United States
(12) Patent Application Publication
(10) Pub. No.: US 2004/0135039 A1
(43) Pub. Date: Jul. 15, 2004

(54) Controlling and identifying system of holders for intravenous lines and other elongated members

(76) Inventors: Lucas Carl Reichert, Lehi, UT (US); Gabriel Garth Reichert, Lehi, UT (US)

Correspondence Address: Lucas Reichert, 3636 West Bay Circle, Lehi, UT, 84043, US

(21) Appl. No.: 10/338,536

(22) Filed: Jan. 9, 2003

(51) Int. Cl. F16L 3/22

(52) U.S. Cl. 248/68.1

(57) ABSTRACT

An organizing set of holders used to manage one or more elongated members such as a plurality of intravenous fluid lines. The holders preferably assume the form of rectangular strips or blocks composed of semi-flexible resilient material such as molded plastic. The holders include holes running through the body perpendicular to the center axis of the rectangle enabling elongated tubes to be captured within the holes. The holders preferably further include an opening at the top of each hole that allows elongated tubes to be slid into the hole or slot in the rectangle at any point along the elongated tube. The holders may be flexed in the opposing direction of the openings so as to spread the openings further apart increasing ease of elongated tube entry into the perpendicular holes. In one configuration, the holder has a closable cover component permanently attached to the body of the holder so as to capture and control elongated tubes placed in the perpendicular holes. A means of retaining the closable cover in the closed position is provided at the opposite end of the holder from the attachment point of the cover. When used together in a set of multiple holders the holders may be used to organize, control and identify intravenous fluid lines or other medical fluid administration lines preventing line entanglement. The holders preferably assume the form of a system of three to five individual holders used in conjunction with one another, being spaced at regular intervals along the elongated members. The system of holders preferably further include an incorporated safety pin or clip that provides means of attaching and securing a holder to bed linen or patient clothing. One or more attachment holders may be used within the system of holders. One or more of the flat surfaces of the holder have a texture, which allows printing of one or more messages concerning the use or re-use of the holder system. Color code is achieved by color spot indentations immediately adjacent to each opening.

### STATEMENT REGARDING FEDERALLY SPONSORED RESEARCH OR DEVELOPMENT

Not Applicable

### BACKGROUND OF INVENTION

During hospitalization certain medical procedures require the administration of fluids to the patient. Such fluids are normally delivered through one or more fluid lines connected to various fluid containers at the distal end and to the patient through catheters, wing needles sets or other means at the proximal end. Multiple lines attached to a patient during procedures, transport, bedridden, or walking about the facility very often become entangled and confused. Also, when bedridden, lines may become lost in bedding, become kinked or folded, thus cutting off flow of necessary medication. A mass of entangled lines creates confusion for the attendants, and raises the anxiety level of patients, family members and other visitors.

There have been several proposals to arrange intravenous lines, but thus far all such proposals have been intended to bundle, protect, label, or organize lines while the patient is in a bedridden state rather than allow patients freedom of mobility while still connected to intravenous lines. Examples include U.S. Pat. Nos. 4,795,429; 4,988,062; 5,224,674; 5,336,179; 5,876,371, and 6,315,759. Using the latter of these as representative, a protective tubular cover for intravenous lines, includes an element having a protective cover for surrounding at least one elongated member and writing surface to identify contents of lines within the protective tube. Multiple protective tubes may be used along the entire length of intravenous lines.

Although mechanisms of this kind help with protection and basic labeling is difficult to prevent line entanglement and confusion within the protective cover, as lines are not individually separated and identifiable. Additionally the protective covers add significant weight and stiffness to the intravenous lines that increases the potential for line detachment. Further, these mechanisms do not provide for a means of securement of organized and identified lines to either bed linen, or personal clothing while a patient is in an ambulatory mode. The need therefore remains for a simple, lightweight means of singlating, identifying, and optionally securing intravenous lines that is lightweight and does not add stiffness to the intravenous lines.

### BRIEF SUMMARY OF INVENTION

This invention resides in a system of holders or organizing line clips that when used in combination along the entire length of one or more elongated members serves to prevent entanglement, identify line contents in any chosen location or locations along the line, and provide means of securing lines to patient clothing or bedding.

Broadly, the invention assumes the form of generally rectangular sections or blocks composed of semi-flexible resilient material such as molded plastic. The holders include openings running through the body perpendicular to the center axis of the rectangle enabling elongated members to be captured within the openings.

The system of holders preferably further include an opening at the top of each opening that allows elongated members to be slid into the opening or slot in the rectangle at any point along the elongated member. The holders may be flexed in the opposing direction of the openings so as to spread the openings further apart increasing ease of elongated member entry into the perpendicular openings.

In one configuration, the holder has a closable cover component permanently attached to the body of the holder so as to capture and control elongated tubes placed in the perpendicular holes. A means of retaining the closable cover in the closed position is provided at the opposite end of the holder from the attachment point of the cover.

The system of holders preferably further include an incorporated safety pin or clip that provides means of attaching and securing a holder to bed linen or patient clothing. One or more attachment holders may be used within the system of holders.

One or more of the flat surfaces of the holder have a texture, which allows printing of one or more messages concerning the use or re-use of the holder system. Color-coding is achieved by color spot indentations immediately adjacent to each opening.

### BRIEF DESCRIPTION OF THE DRAWINGS

FIG. 1 is a drawing that shows from the front view perspective, a line organizer according to the slit into opening embodiment of the invention.

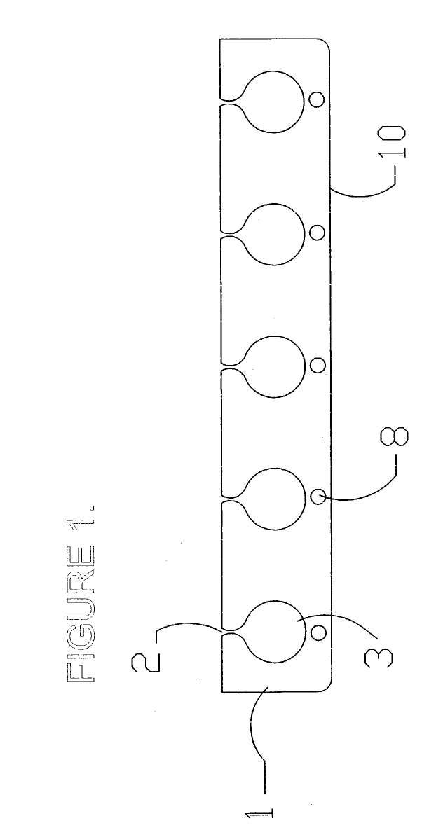

FIG. 2 is a drawing that shows, from the front view perspective, a line organizer according to the closable cover embodiment of the invention.

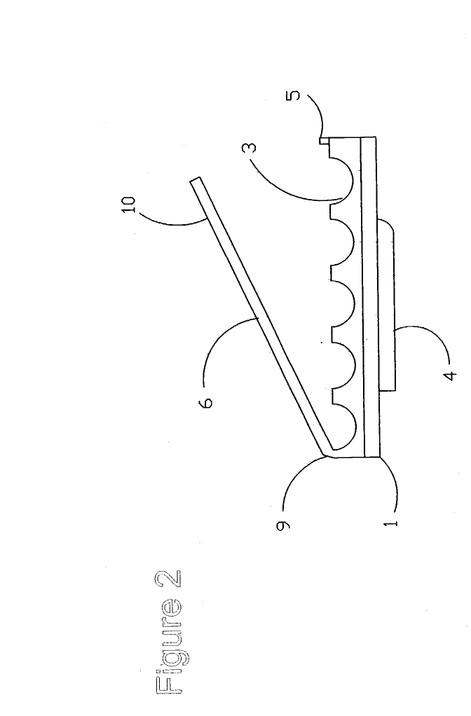

FIG. 3 is a drawing that shows, from the top view perspective, the system of line organizers or holders when being used in combination with each other according to the embodiment of the invention.

### DETAILED DESCRIPTION OF THE INVENTION

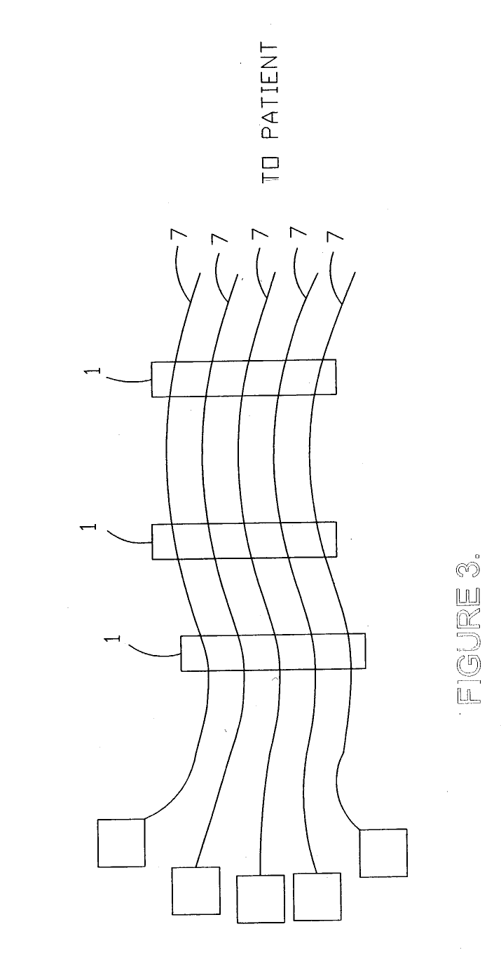

Broadly this invention solves the disadvantages of prior art by providing a system of holders that is lightweight; do not stiffen intravenous lines, and singelates lines from each other to prevent confusion of lines or entanglement of lines, depicted in FIG. 3. The system of holders, each holder being preferably made of semi-flexible resilient material such as molded plastic, may be spaced at intervals along intravenous lines of any length as depicted in FIG. 3. Once in position the holders may be slide ably adjusted along the length of the line as desired by the user. The system of holders is very small and lightweight, not adding any significant weight to the intravenous line system in use.

The holder 1 is placed over the lines 7 one line at a time by flexing the holder 1 backwards thus increasing the width of slit 2 making insertion of the line 7 easier into opening 3.

The openings 3, in the preferred embodiment, are of a size small enough to exert slight pressure on the line 7 so that they stay in position after positioning, but not too much pressure as to restrict flow within the line.

Alternately the preferred embodiment may allow for openings 3 to be accessed by lifting cover 6, placing lines 7 into openings and then closing cover 6. The cover 6 is permanently connected to holder body 1 by means of a live hinge 9, thus preventing loss of the cover during holder placement. The cover 6 is secured in place by clasp 5 after line insertion and cover closure.

Holders may be attached to bed linen or patient clothing using permanently attached safety pin 4, as desired by user. This feature of the preferred embodiment allows intravenous lines to remain connected and in control, preventing dangerous entanglement even while patient is walking around, taking physical therapy or receiving other treatments requiring their mobility.

Printable surfaces 10 are provided on either embodiment of the invention. Information such as dates, type of medication or the like may be written on these surfaces as desired by user.

Color code dots 9 are provided for ease of line identification depending on the protocol of the institution using the holders

We claim:

1. A system of holders for organizing and controlling one or more elongated members, comprising:
one or more generally rectangular members composed of resilient, flexible material, the rectangle having a length, a width, a depth, and multiple holes or slots perpendicular to the length axis of the rectangular members;
slots or holes of a size to allow the holders to be slideably positioned anywhere along the elongated members contained within the slots or holes;
holes or slots of varying sizes to accommodate varying sizes of elongated members;
a clip, pin, or other means of temporarily attaching one or more of the holders within the system or holders to bedding or personal clothing;
a flat, printable surface containing a message concerning the use or re-use of the system of holders;
a color code scheme to identify separate lines as to content such as normal saline solution.

2. The system of holders of claim 1, further including a slit parallel with and intersecting the holes through the width of the rectangular members, enabling one or more elongated tubes to be slid into the holes as the rectangle is flexed along the surface opposite the slits.

3. The system of holder of claim 1, further including a hinged cover permanently attached to the rectangular member so as to close the hole opening after insertion of one or more elongated members into one or more of the perpendicular slots;
a means of retaining the cover in the closed position.
